(19) United States
(12) Patent Application Publication
(10) Pub. No.: US 2019/0144203 A1
(43) Pub. Date: May 16, 2019

(54) LEAF COLLECTION APPARATUS

(71) Applicant: JCS Ventures, Aurora, CO (US)

(72) Inventors: Roger Jetter, Aurora, CO (US); Robert Sonnichsen, Aurora, CO (US); Gary Constant, Golden, CO (US)

(73) Assignee: JCS Ventures, Aurora, CO (US)

(21) Appl. No.: 16/189,953

(22) Filed: Nov. 13, 2018

Related U.S. Application Data
(60) Provisional application No. 62/587,308, filed on Nov. 16, 2017.

(51) Int. Cl. B65F 1/10; B65B 67/12

(52) U.S. Cl. CPC B65F 1/10; B65F 2220/102; B65F 2240/138; B65B 67/1238

(57) ABSTRACT

An apparatus for the collection of debris such as leaves and other yard debris having a flat-pack configuration and a hoop-like configuration. In a hoop-like configuration, the apparatus allows the fixation of a bag such that the bag is held open and allows the user to dispose debris through the apparatus and into the bag.

### CROSS REFERENCE TO REFERENCE TO RELATED APPLICATIONS

This application claims the benefit of U.S. Provisional Patent Application 62/587,308 entitled “LEAF COLLECTION APPARATUS” filed on Nov. 16, 2017, the entire contents of which are incorporated herein by reference in its entirety for all purposes.

### FIELD OF THE INVENTION

The present invention is directed to the field of the collection and disposal of debris such as dust, yard waste or other types of debris.

### BACKGROUND OF THE INVENTION

The collection of matter such as dust, trash, yard waste, or other general debris, herein referred to as debris, is a common activity for maintaining the cleanliness of an area. Debris collection may be necessary as general cleaning and maintenance, or following activities such as construction. Another common need for debris collection surrounds annual leaf collection or other debris producing events.

The collection of debris commonly surrounds the aggregation of debris, the transfer of debris to a receptacle, placing the debris within the receptacle and then the disposal of the receptacle into the waste stream.

The aggregation of debris is typically performed with an aggregating device such as a broom, rake or other device appropriate for the type of debris for collection. The transferring of the debris is typically performed with a transferring device such as a shovel, dustpan, rake, or other device appropriate for the type of debris being transferred. The transferring device is used to transfer the debris from the area in which it is aggregated to a receptacle such as a trash bag. In certain situations, an intermediate receptacle such as a bucket, is used to hold the debris prior to the transferring to a receptacle.

A typical process surrounding debris collection and disposal requires the flexion of one's back and knees in a repetitive manner. Repetitive motions such as this are inefficient, tiresome and can be painful or injurious. Sometimes, when collecting debris, an individual is required to kneel on the ground which can be difficult and/or painful for some individuals. Collection of debris in a traditional manner can result in an individual developing or exacerbating conditions such as prepatellar bursitis, arthritis, or repetitive motion disorders of the spine, knees or other joints.

In light of the potential injurious nature of debris collection and disposal, there is a need for an apparatus that assists in preventing repetitive motion, limiting joint flexion, and making the process of debris collection more efficient.

### SUMMARY OF THE INVENTION

It is an object of the present invention to allow users to collect and dispose of debris in a manner which is more time and energy efficient while limiting knee and back flexion, thus reducing potential for injurious conditions. Certain embodiments of the present invention provide solutions to limit the number of steps required for collecting and disposing of debris. Certain embodiments surround the aggregation of debris directly into a receptacle, such as a bag. Aggregating debris directly into a receptacle omits the step of transferring the debris from the area of aggregation to a receptacle, thus making the process of collecting and disposing of debris more efficient.

Certain existing technologies have attempted to provide a solution to the problem providing an apparatus for the collection and disposal of debris. Inventions such as those disclosed by U.S. Pat. No. 3,998,415 to D'Antonio, et al. (“D'Antonio”), incorporated by reference herein, provides an apparatus for holding a bag open. However, D'Antonio requires the use of many parts. The misplacement of any part renders the apparatus inoperable. Similarly, the “Rake Mate” disclosed in U.S. Pat. No. 5,009,378 to Linsmeyer (“Linsmeyer”), incorporated by reference herein, also requires the use of many parts. Additionally, the invention of Linsmeyer is bulky, resulting in high cost of shipping and requires a large amount of space for storage when not in use.

Inventions such as those disclosed by U.S. Pat. No. 5,011,103 to Hayes, et al. (“Hayes”), U.S. Pat. No. 5,183,339 to Williams (“Williams”), and U.S. Pat. No. 4,615,743 to Bylenga (“Bylenga”), U.S. Patent Application No. 2005/0087657 to Dran (“Dran”), all incorporated by reference herein, fail to hold a bag in a manner for the leading edge of the bag to rest at the same level of the aggregated debris. As a result, some debris pushed toward the open bag held by each apparatus is disposed under the leading edge of the bag or against the leading edge of the bag rather than into the bag. Furthermore, the invention of Hayes requires the use of a specialized bag which must then be emptied into a second bag, counteracting a potential benefit of efficiency in the collection and disposal of debris.

Inventions such as those disclosed by U.S. Pat. No. 4,659,045 to Flynn (“Flynn”) and U.S. Pat. No. 6,450,461 to Lohmann (“Lohmann”), incorporated by reference herein, result in an apparatus which are large and cumbersome. The shipping and storage of such apparatus require a large amount of storage space and are costly to ship. Furthermore, the handles of Flynn are located toward the bottom of the apparatus and require a user to repeatedly put their back and/or knees in a state of flexion.

Inventions such as disclosed by U.S. Pat. No. 4,664,348 to Corsaut (“Corsaut”), incorporated by reference herein, provide a low-profile apparatus for holding a bag. Corsaut discloses an apparatus which can be configured to lay flat when not in use to provide ease of transport and storage. However, the invention of Corsaut fails to provide a user with a handle to assist in manipulating the apparatus, thus resulting in requiring a user to repeatedly put their back and/or knees in flexion.

It is an aspect of the certain embodiments of the present invention to hold a bag in an open configuration.

It is an aspect of the present invention to allow a user to use embodiments of the present invention without the need to kneel, or place their back in flexion. Certain embodiments of the present invention provide a handle located at a high-point of the apparatus.

It is an aspect of various embodiments to allow the storage and/or transportation of an apparatus without requiring a large volume for shipping or storage when not in use. Certain embodiments of the present invention have a flat-pack structure. A flat-pack structure provides increased transportability and minimizing storage space when the apparatus is not in use. Such an apparatus comprises a scoop with a leading edge configured to rest upon a ground surface and extensions affixed to the sides of scoop. The extensions, made of a flexible material are typically hinged at the sides of the scoop and are configured to hinge toward the scoop. When hinged toward the scoop, the extensions flexibly interface with each other to create a hoop configuration. The extensions are mated to each other in a manner to maintain the hoop configuration. The hoop configuration is then disposed into the open end of a bag such that the leading edge of the scoop extends out of the bag opening and a trailing edge of the scoop extends into the bag. Thus, the apparatus keeps the bag open and the leading edge of the apparatus provides a low-profile edge for ease of depositing debris through the apparatus and into the bag.

Certain embodiments of the present invention comprise a scoop having a bevel on the leading edge. The bevel of the leading edge of the scoop allows for easier depositing of debris through the apparatus without the debris catching on the leading edge of the scoop.

Certain embodiments comprise retention mechanisms for the attachment of a trash-bag, or other receptacle, to the apparatus. Retention mechanisms typically serve to attach a receptacle to an exterior surface of the apparatus. However, it will be appreciated that if desired, a retention mechanism for affixing a receptacle to the interior surface of the apparatus does not depart from the inventive concept of the present invention. It will be further appreciated that retention mechanisms of many types provide retention of a trash bag while in keeping with the inventive nature of the present invention. Such retention mechanisms include: holes, snap closures, and other mechanisms consistent with the inventive nature of the present invention.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary.

Additional aspects of the present invention will become more readily apparent from the detailed description, particularly when taken together with the drawings, and the claims provided herein.

### BRIEF DESCRIPTION OF THE DRAWINGS

FIG. 1—A plan-view of embodiments in a flat-configuration

FIG. 2—A plan-view of a hinge of certain embodiments

FIG. 3—A plan-view of embodiments in a flat-configuration

FIG. 4A-A close-up view of extension attachments of certain embodiments

FIG. 4B-A perspective assembled view of embodiments of the present invention

FIG. 5A-A close-up view of extension attachments of certain embodiments

FIG. 5B-A perspective assembled view of embodiments of the present invention

FIG. 6A-A perspective assembled view of embodiments of the present invention

FIG. 6B-A close-up view of retention components of certain embodiments

FIG. 7A-A perspective assembled view of embodiments of the present invention

FIG. 7B-A close-up view of retention components of certain embodiments

### DETAILED DESCRIPTION OF VARIOUS EMBODIMENTS

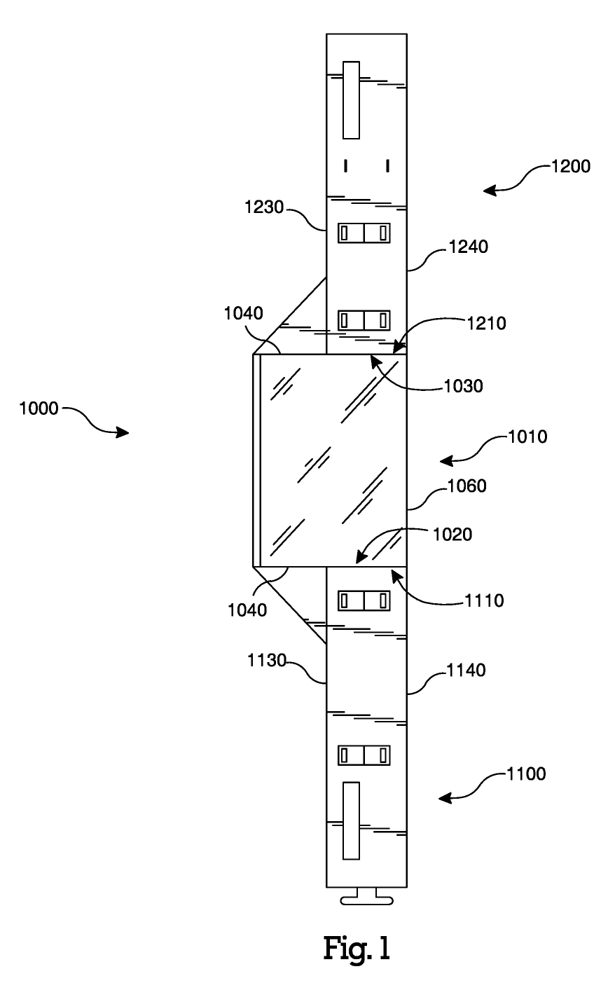

Certain embodiments of the invention comprise a bag holding apparatus 1000, shown in FIG. 1 having a sheet-form manufactured from a flexible material, typically having elastic or semi-elastic properties. The apparatus comprises a scoop 1010, having a first end 1020 and second end 1030. Affixed to the first end 1020 of the scoop, is a first extension 1100 having a first end 1110 affixed to the first end 1020 of the scoop. Affixed to the second end 1030 of the scoop is a second extension 1200 having a first end 1210 affixed the second end 1030 of the scoop.

It will be appreciated that an apparatus 1000, as shown in FIG. 1, comprises a scoop 1010, a first extension 1100, and a second extension 1200 having a singular form cut from a single piece of sheet-stock or plate-stock. In other embodiments of the present invention, a scoop 1010, a first extension 1100, and a second extension 1200 are independent structures which are assembled and affixed as described herein.

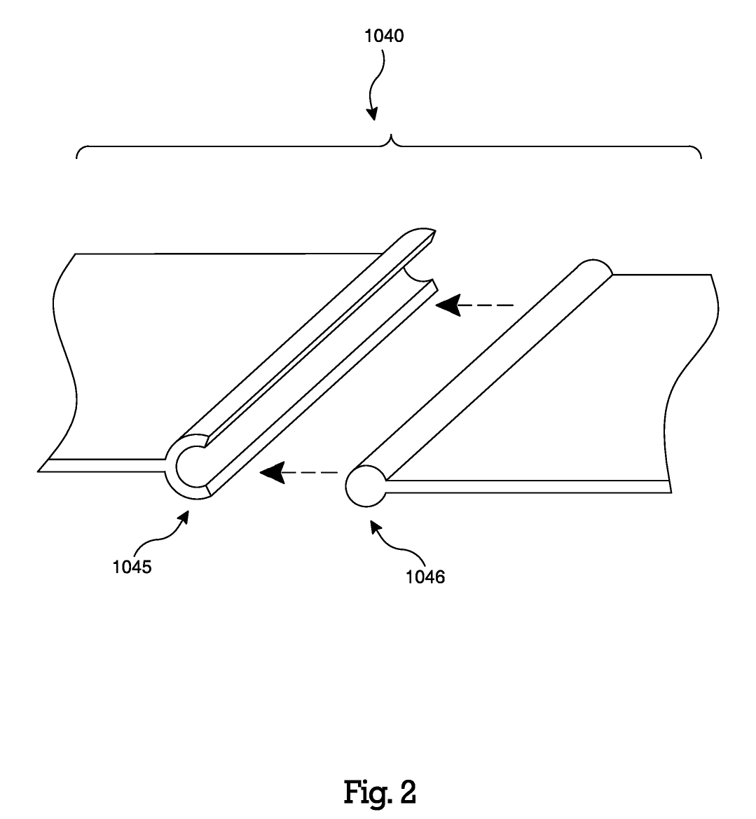

Certain embodiments, shown in FIG. 1 and FIG. 2, comprise an attachment of a first end 1110 of a first extension to a first end 1020 of a scoop comprises a hinge 1040. A hinge 1040 as disclosed herein provides an attachment mechanism which allows rotational movement of a first extension 1100 about the first end 1110 of the first extension. Certain embodiments, shown in FIG. 2, comprise a hinge 1040 having hinge elements 1045 and 1046. The first hinge element 1045 mates with a second hinge element 1046 to provide rotational movement. Certain embodiments comprise a first extension 1100 attached to a scoop 1010 with a living hinge. A living hinge is appreciated to comprise a hinge mechanism using material that flexes to allow rotational movement. Other embodiments comprise a piano hinge, or other hinge mechanisms known to those skilled in the art.

Certain embodiments of the present invention, shown in FIG. 1, comprise a scoop 1010, a first extension 1100, and a second extension 1200. In such embodiments, a trailing edge 1060 of a scoop aligns with a trailing edge 1140 of a first extension and a trailing edge 1240 of a second extension. A leading edge 1130 of the first extension is further aligned with the leading edge 1230 of the second extension. Furthermore, a leading edge 1050 of the scoop is offset from the leading edge 1130 of the first extension.

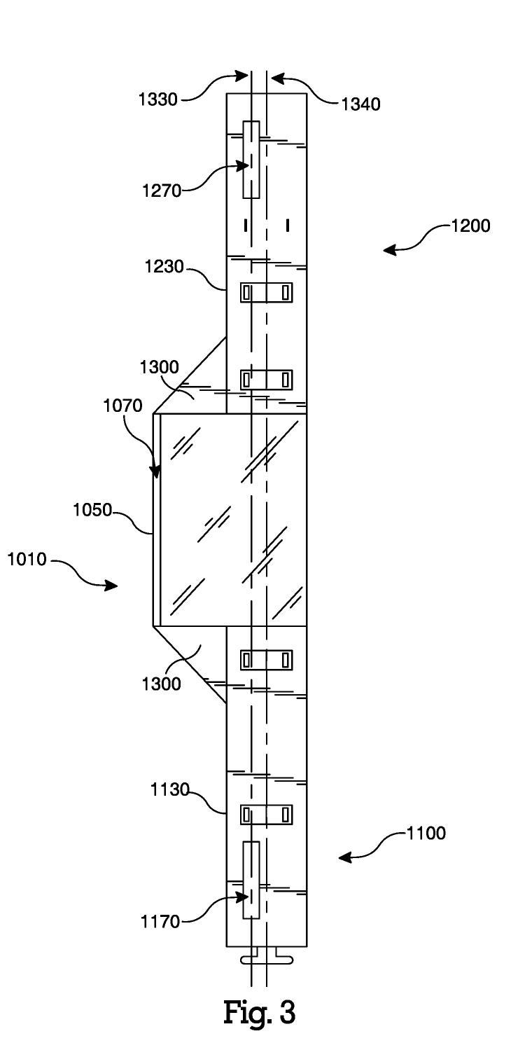

Certain embodiments, shown in FIG. 3, comprise a scoop 1010 having a leading edge 1050 offset from the leading edge 1130 of a first extension. Certain embodiments having a scoop 1010 and a first extension 1100, further comprise a gusset 1300. In such embodiments, a first gusset 1300 bridges between the leading edge 1130 of the first extension and the leading edge 1050 of the scoop. Some embodiments of the present invention comprising a first gusset 1300 further comprise a second gusset 1300 bridging between the leading edge 1050 of the scoop and the leading edge 1230 of a second extension 1200. A gusset comprises an independent piece of material affixed to the scoop 1010 and a first extension 1100. Certain embodiments comprise a first gusset 1300 affixed to the scoop 1010 and the first extension 1100, and a second gusset 1300 affixed to the scoop 1010 and the second extension 1200. Some embodiments comprise gussets 1300 which are integral portions of the first extension 1100 and the second extension 1200. It will be further appreciated that a first gusset 1300 and a second gusset 1300 as disclosed are proximal to but not required to be coincident with the leading edge 1050 of the scoop. In certain embodiments, a scoop 1010 comprises a leading edge 1050 further comprising a bevel 1070. A bevel 1070 provides a lower profile leading edge 1050 for increased ability to dispose debris over the leading edge 1050 and through the apparatus 1000 in a receptacle.

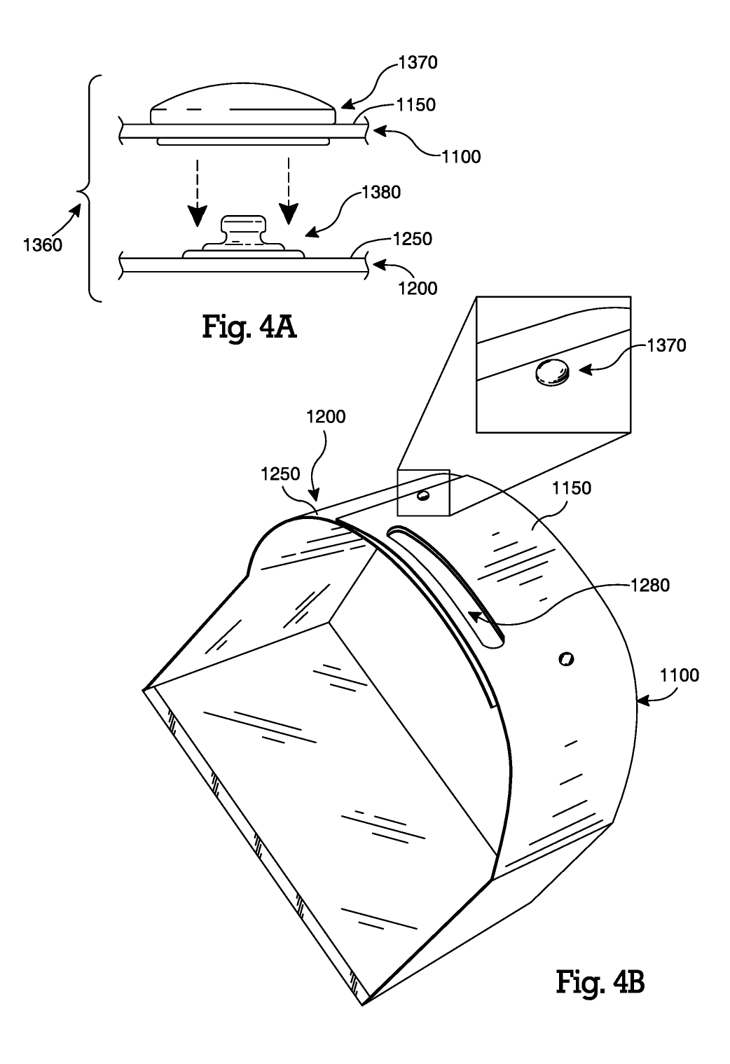

Certain embodiments of the present invention, shown in FIG. 4A and FIG. 4B, further comprise an extension attachment 1360. An extension attachment 1360, as disclosed, provides the ability to constrain a first extension 1100 to a second extension 1200 in a desired configuration. Certain embodiments of the present invention comprise an extension attachment 1360, and further comprise a first button snap 1370 and a second button snap 1380. A first button snap 1370 located on a first surface 1150 of a first extension is configured to mate with a second button snap 1380 on a first surface 1250 of a second extension. When mated, the first extension 1100 is constrained to the second extension 1200, thus configuring the apparatus in a hoop configuration, as shown in FIG. 4B.

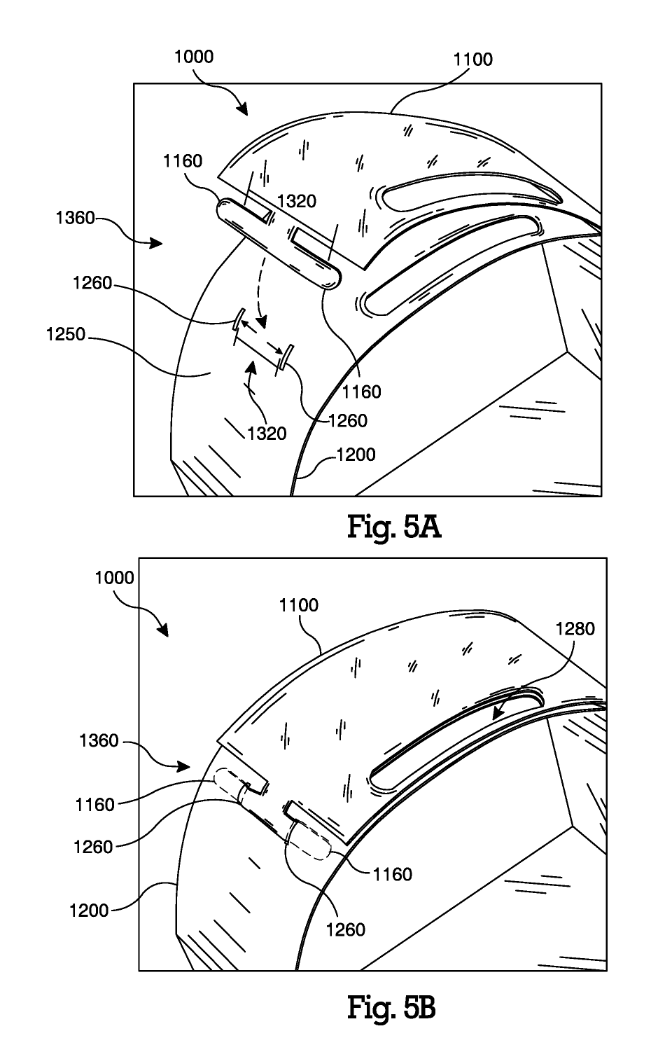

Certain embodiments of the present invention comprise an extension attachment 1360, referencing FIG. 5A and FIG. 5B, comprise a tab 1160 and a slot 1260. In such embodiments, a tab 1160 mates with and is retained by a slot 1260. In certain embodiments, a first tab 1160 is affixed to a first extension, proximal to a second end 1120. The first tab 1160 is configured to mate with and be retained by a first slot 1260 through the first surface 1250 of the second extension. When the first tab 1160 is mated with the first slot 1260, the first extension 1100 is constrained to the second extension 1200, thus configuring the apparatus 1000 in a hoop configuration, as shown in FIG. 4B. It will be appreciated that an apparatus may use a plurality of extension attachments 1360 to provide increased constraint between a first extension 1100 and a second extension 1200.

Certain embodiments, shown in FIG. 5A and FIG. 5B, comprise a first tab 1160 and a second tab 1160 affixed to the second end 1120 of the first extension. The first tab 1160 and the second tab 1160 are typically offset perpendicularly from the trailing edge 1140 of the first extension. The first tab 1160 and the second tab 1160 are separated by a first distance 1320. Certain embodiments further comprise a first slot 1260 and second slot 1260 through the second extension. The first slot 1260 is offset from the trailing edge 1240 such that the first slot 1260 is aligned with the first tab 1160. The second slot 1260 is offset from the first slot 1260 by the first distance 1320 such that the second slot 1260 is aligned with the second tab 1160.

Certain embodiments of the present invention, shown in FIG. 3, comprise a first extension 1100 having a first aperture 1170, and a second extension 1200 having a second aperture 1270. The placement of the first aperture 1170 and the placement of the second aperture 1270, are configured such that the fixation of a first extension 1100 to a second extension 1200 results in the alignment of the first aperture 1170 with the second aperture 1270, typically toward the top of the apparatus. In certain embodiments, a first aperture 1170 and a second aperture 1270 are coincident with an axis 1330 offset from, and parallel to, the trailing edge 1140 of the first extension. The first aperture 1170 is offset from the second end 1120 of the first extension, and the second aperture is offset from the second end 1220 of the second extension. The alignment of a first aperture 1170 with a second aperture 1270, serves to provide a handle 1280, shown in FIG. 4B and FIG. 5B. The handle 1280 allows a user to manipulate the apparatus when in use.

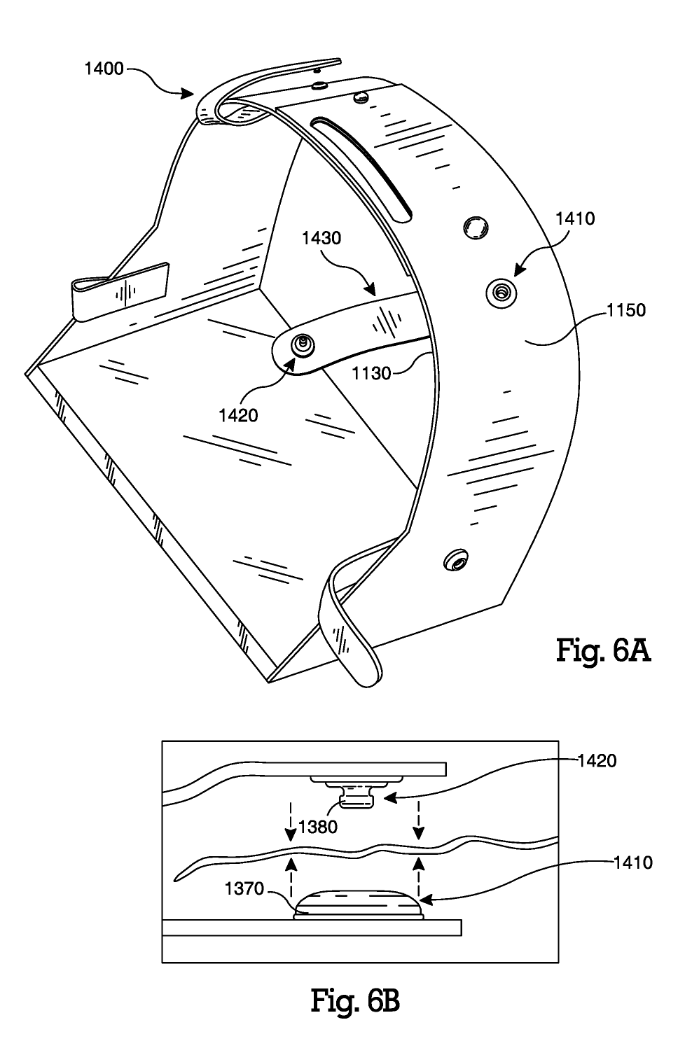

Certain embodiments, further comprise retention mechanisms 1400, shown in FIG. 6A and FIG. 6B, for the purpose of constraining a receptacle, such as a trash bag. A retention mechanism 1400, comprises a first retention component 1410 affixed to a first surface 1150 of an extension, and a second retention component 1420 affixed to a flexible protrusion 1430. A flexible protrusion 1430, is affixed to the leading edge 1130 of the first extension and allows the mating of the first retention component 1410 and the second retention component 1420. It will be appreciated that certain embodiments of the invention a first retention component 1410 and a second retention component 1420, further comprising a first button snap 1370 and a second button snap 1380.

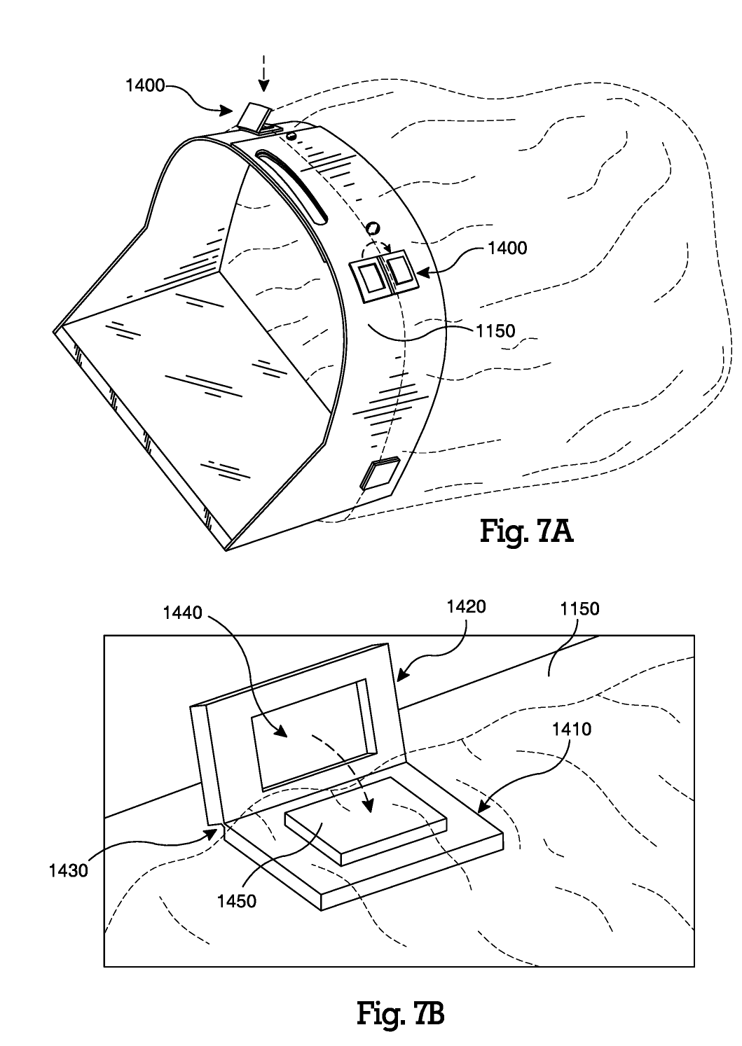

In certain embodiments, as shown in FIG. 7A and FIG. 7B, a retention mechanism 1400 comprises a first retention component 1410 and a second retention component 1420. The first retention component 1410, affixed to the first surface 1150 of a first extension comprises a volume 1450 having a profile. The profile of the volume 1450 comprises, but is not limited to a square, rectangle, circle, or a polygon. The second retention component 1420 is integrated with a flexible protrusion 1430 affixed to the first surface 1150 of the first extension and is configured to mate with the first retention component 1410. In such embodiments, the second retention component 1420 comprises an opening 1440 having a profile matching that of the first retention component 1410 and is configured to have an engineering fit with the first retention component 1410. An engineering fit will be appreciated to surround a location fit, RC fit, or other engineering fit such as those specified by ANSI B4.1 (Standard Tolerance Limits and Fits), incorporated by reference herein. It will be further appreciated that other engineering fits or assembly strategies known to those skilled in the art may be used while maintaining the inventive spirit of the present invention.

When the first retention component 1410, shown in FIG. 6A-FIG. 7B for example, is mated with a second retention component 1420 with a receptacle disposed therebetween, the receptacle is constrained to the apparatus. Certain embodiments of the present invention comprise a plurality of retention mechanisms 1400. In certain embodiments, shown in FIG. 3, a plurality of retention mechanisms 1400 are coincident with an axis 1340 offset from, and parallel to, the trailing edge 1140 of the first extension.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. An apparatus for debris collection comprising:
a scoop located between a first extension and a second extension, the extensions extending away from the scoop;
the extensions comprising a flexible material;
a first end of the scoop attached to a first end of the first extension with a first hinge, the first extension extending away from the scoop in a first direction;
a second end of the scoop attached to a first end of the second extension with a second hinge, the second extension extending away from the scoop in a second direction, substantially parallel to the first direction;
a first extension attachment affixed to the first extension, and proximal to a second end of the first extension;
a second extension attachment affixed to the second extension, and located between the first end and a second end of the second extension; and
the first extension attachment configured to mate with the second extension attachment,
wherein the mating of the extension attachments results in the fixation of the first extension to the second extension, thus configuring the apparatus from a flat configuration to a hoop configuration, and
wherein the scoop remains flat when the apparatus is in a hoop configuration.

2. The apparatus of claim 1 wherein, the first extension attachment comprises a first button snap affixed to a surface of the first extension; and
the second extension attachment comprises a second button snap affixed to a surface of the second extension.

3. The apparatus of claim 1 wherein, the first extension attachment comprises a first tab affixed to the second end of the first extension; and
the second extension attachment comprises a first slot through the second extension.

4. The apparatus of claim 3 wherein, the first extension attachment further comprises a second tab; and
the second extension attachment further comprises a second slot through the second extension.

5. The apparatus of claim 1 further comprising, a first aperture through the first extension, the first aperture located between the first extension attachment and the scoop; and
a second aperture through the second extension,
wherein the second aperture is configured to align with the first aperture when the apparatus is configured in a hoop configuration.

6. The apparatus of claim 1 wherein, a leading edge of the scoop is offset from a leading edge of the first extension and a leading edge of the second extension in a third direction,
wherein the third direction is substantially perpendicular to the first direction and the second direction.

7. The apparatus of claim 6, further comprising a first gusset bridging the leading edge of the scoop and the leading edge of the first extension; and
a second gusset bridging the leading edge of the scoop and the leading edge of the second extension.

8. The apparatus of claim 6 wherein, the leading edge of the scoop comprises a bevel.

9. The apparatus of claim 1, further comprising a first retention component affixed to a surface of the first extension;
a second retention component configured to mate with the first retention component,
wherein the mating of the retention components results in the fixation of the first retention component to the second retention component.

10. The apparatus of claim 9 further comprising, a flexible protrusion having a first portion affixed to the first extension, and a second portion of the flexible protrusion affixed to the second retention component,
wherein the second retention component is flexibly attached to the first extension.

11. The apparatus of claim 10 wherein, the first retention component comprises a first button snap, and the second retention component comprises a second button snap.

12. The apparatus of claim 10 wherein, the first retention component comprises a volume having a profile;
the second retention component comprises an opening having a profile configured to mate with the volume of the first retention mechanism component.

13. An apparatus for debris collection comprising:
a scoop located between a first extension and a second extension;
the scoop comprises a substantially rectangular form, a first end, and a second end;
the first end of the scoop is coincident with a first end of the first extension, and the second end of the scoop is coincident with a first end of the second extension;
the scoop further comprises a trailing edge coincident with a trailing edge of the first extension and a trailing edge of the second extension;
the first extension further comprises a leading edge aligned with a leading edge of the second extension;
the scoop further comprises a leading edge parallel to the leading edge of the first extension and the leading edge of the second extension, the leading edge of the scoop comprises a bevel, and the leading edge of the scoop is offset from the leading edge of the first extension and the leading edge of the second extension;
a first gusset bridging between the leading edge of the scoop and the leading edge of the first extension;
a second gusset bridging between the leading edge of the scoop and the leading edge of the second extension;
a first tab and a second tab affixed to a second end of the first extension, and the first tab offset from the second tab by a first distance;
a first slot and a second slot through the second extension, and the first slot offset by the first distance from the second slot;
a first retention mechanism affixed to the first extension and a second retention mechanism affixed to the second extension;
a first aperture through the first extension consistent with a first axis and offset from the second end of the first extension toward the first end of the first extension; and
a second aperture through the second extension consistent with the first axis,
wherein the mating of the tabs with the slots results in the fixation of first extension to the second extension such that the apertures align, and resulting in the apparatus is configured from a flat configuration to a hoop configuration, and
wherein the scoop remains flat when the apparatus is in a hoop configuration.
